(19) United States
(12) Patent Application Publication
(10) Pub. No.: US 2008/0089969 A1
(43) Pub. Date: Apr. 17, 2008

(54) Barrel head of extruder of molding system, barrel head having outer and inner portions, amongst other things

(75) Inventors: Valentin Diaconu, Etobicoke (CA); Peter Adrian Looije, Newmarket (CA); Robert Domodossola, Brampton (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, US

(73) Assignee: Husky Injection Molding Systems Ltd., Bolton (CA)

(21) Appl. No.: 11/548,919

(22) Filed: Oct. 12, 2006

(51) Int. Cl. B29C 47/00

(52) U.S. Cl. 425/261; 425/381

(57) ABSTRACT

Disclosed is: (i) a first conduit of an extruder of a molding system, (ii) an extruder of a molding system, (iii) a molding system, (iv) a hot runner of a molding system, (v) a molding system, including a hot runner, and (vi) a method, amongst other things.

### RELATED APPLICATIONS

Similar subject matter is discussed in the related applications entitled: (i) MOLDING SYSTEM INCLUDING BODY OVERLAPPING AND SEALING CONDUITS, AMONGST OTHER THINGS (Applicant's reference number H-1012-0-US), and (ii) MOLDING SYSTEM HAVING CONDUITS HAVING CONICALLY-SHAPED MATABLE DISTAL ENDS, AMONGST OTHER THINGS (Applicant's reference number H-1032-0-US).

### TECHNICAL FIELD

The present invention generally relates to, but is not limited to, molding systems, and more specifically the present invention relates to, but is not limited to, (i) a first conduit of an extruder of a molding system, (ii) an extruder of a molding system, (iii) a molding system, (iv) a hot runner of a molding system, (v) a molding system, including a hot runner, and (vi) a method, amongst other things.

### BACKGROUND

Examples of known molding systems are (amongst others): (i) the HyPET™ Molding System, (ii) the Quadloc™ Molding System, (iii) the Hylectric™ Molding System, and (iv) the HyMet™ Molding System, all manufactured by Husky Injection Molding Systems Limited (Location: Bolton, Ontario, Canada; www.husky.ca).

U.S. Pat. No. 5,002,717 (Inventor: Taniguchi; Published: 1991-03-26) discloses control of injection by injection molder in which fluctuation in weighed resin amout is eliminated even when suck back motion is carried out. More specifically, this patent discloses a method for controlling the injection of a molten resin through an in-line screw type injection molding machine. The molding machine is equipped with a check ring for permitting the injection of the molten resin by an advancement of the screw and also for preventing the molten resin from flowing backward. According to the method, the screw is rotated in the normal direction to knead and plasticize a resin material and further to feed the resultant molten resin to the free end portion of the screw. The screw then retracts to meter and store a predetermined quantity of the molten resin adjacent to the free end portion of the screw. The screw is next rotated in the reverse direction to pressure of the molten resin on the rear side of the check ring lower than that of the molten resin thus metered and stored on the front side of the check ring. The screw retracts to reduce the pressure of the resin on the front side of the check ring, thereby performing a decompression stroke. The screw finally advances to inject the molten resin into a mold.

World Intellectual Property Organization Patent Number WO 9500312 (Inventor: WOLFF; Published: 1995-01-05) discloses a hot runner distributor for supplying molten thermoplastic materials to hot nozzles at molding tools that has pipe plug-type connections that allow thermal expansion. Each pipe plug-type connection has two mutually aligned pipe ends which surround the runner of molten material and are mutually separated by an expandable joint. Both pipe ends are enclosed in the area of the expandable joint by a common cooling ring. The molten plastic material which solidifies under the action of the cooling ring seals the pipe plug-type connection in the area of the expandable joint.

U.S. Pat. No. 6,942,006 (Inventor: KONO; Published: 13 Sep. 2005) discloses a metal injection molding apparatus with features which reduce the amount of metal which enters a drive mechanism of the apparatus. The apparatus contains an injection chamber having an accumulation portion and a shaft housing portion. The shaft housing may extend all the way to the position of an injection member in a fully retracted position. The accumulation portion and the shaft housing may comprise different vessels attached to each other with an insulating gasket provided therebetween. The insulator material of the gasket is preferably made of asbestos, a heat insulating ceramic or any other suitable heat resistant material. The material to be injected, such as a liquid or thixotropic metal, enters the injection chamber through an entry opening configured in the accumulation portion, and exits the accumulation portion, when injected, through a nozzle aperture configured at an end of the accumulation portion and into the mold. The shaft housing portion may include openings in the sidewalls through which any melt leakage past from the injection member that has not been caught by a series of piston rings may egress. Accordingly, the shaft housing, and gasket, is not configured to experience pressurized melt of molding material.

United States published patent application Number 2005/0255189 (Inventor: MANDA, Jan; et al; Published: 17 Nov. 2005) discloses a cooled connection between melt conduits of a runner system to form a seal of at least partially solidified molding material (a metallic molding material). Discloses is a seal in the metal molding system, such as those between melt conduit components of a barrel assembly and a runner system. US No. 2005/0255189 discloses a cooled interface for providing a seal of at least partially solidified molding material between the components of the runner system. A problem with the cooled interface may occur when the amount of heat required to be removed to effect the seal of at least partially solidified molding material is also sufficient to over-cool an adjacent portion of a melt passageway and cause a plug of at least partially solidified molding material to form therein which may affect the proper flow of the molding material therethrough. Others have relied on face seals across a clamped interface between mating faces of adjacent melt conduits. In practice, the mating faces of the melt conduits that form the interface do not adequately conform to one another to affect a reliable seal against the leakage of the generally low viscosity molding material under the injection pressure.

### SUMMARY

According to a first aspect of the present invention, there is provided a first conduit of an extruder of a molding system, including (amongst other things): a body configured to be connectable with a second conduit, the body configured to have an outer portion, the body also configured to have an inner portion, the inner portion configured to be receivable, at least in part, in the outer portion.

According to a second aspect of the present invention, there is provided a first conduit of an extruder of a molding system, including (amongst other things): a body connected with a second conduit, the body having an outer portion, the body also having an inner portion, the inner portion received, at least in part, in the outer portion.

According to a third aspect of the present invention, there is provided an extruder of a molding system, including (amongst other things): a first conduit having a body, the body connected with a second conduit, the body having an outer portion, and the body also having an inner portion, and the inner portion received, at least in part, in the outer portion.

According to a fourth aspect of the present invention, there is provided an extruder of a molding system, including (amongst other things): a first conduit, and a second conduit, wherein the first conduit has a body, the body connected with a second conduit, the body has an outer portion, and the body also has an inner portion, and the inner portion is received, at least in part, in the outer portion.

According to a fifth aspect of the present invention, there is provided an extruder of a molding system, including (amongst other things): a first conduit configured to have a body, the body configured to be connectable with a second conduit, the body configured to have an outer portion, the body also configured to have an inner portion, and the inner portion configured to be receivable, at least in part, in the outer portion.

According to a sixth aspect of the present invention, there is provided a molding system, including (amongst other things): a stationary platen supporting a stationary mold portion of a mold, a movable platen supporting a movable mold portion of the mold, and an extruder including a first conduit, the first conduit having a body, the body connected with a second conduit, the body having an outer portion, and the body also having an inner portion, and the inner portion received, at least in part, in the outer portion.

According to a seventh aspect of the present invention, there is provided a molding system, including (amongst other things): a stationary platen supporting a stationary mold portion of a mold, a movable platen supporting a movable mold portion of the mold, and an extruder including: a first conduit, and a second conduit, wherein the first conduit has a body, the body connected with a second conduit, the body has an outer portion, and the body also has an inner portion, and the inner portion is received, at least in part, in the outer portion.

According to a eighth aspect of the present invention, there is provided a molding system, including (amongst other things): a stationary platen configured to support a stationary mold portion of a mold, a movable platen configured to support a movable mold portion of the mold, and an extruder configured to includes a first conduit, the first conduit configured to have a body, the body configured to be connectable with a second conduit, the body configured to have an outer portion, the body also configured to have an inner portion, and the inner portion configured to be receivable, at least in part, in the outer portion.

According to a ninth aspect of the present invention, there is provided a molding system, including (amongst other things): a mold having a stationary mold portion, the mold also having a movable mold portion of the mold, a stationary platen supporting the stationary mold portion of the mold, a movable platen supporting the movable mold portion of the mold, and an extruder including a first conduit, the first conduit having a body, the body connected with a second conduit, the body having an outer portion, and the body also having an inner portion, and the inner portion received, at least in part, in the outer portion.

According to a tenth aspect of the present invention, there is provided a hot runner of a molding system, including (amongst other things): a first conduit having a body, the body connected with a second conduit, the body having an outer portion, and the body also having an inner portion, and the inner portion received, at least in part, in the outer portion.

According to an eleventh aspect of the present invention, there is provided a molding system, including (amongst other things): a hot runner, including: a first conduit, and a second conduit, wherein the first conduit has a body, the body connected with a second conduit, the body has an outer portion, and the body also has an inner portion, and the inner portion is received, at least in part, in the outer portion.

According to a twelfth aspect of the present invention, there is provided a method, including (amongst other things): receiving an inner portion, at least in part, in an outer portion, the inner portion and the outer portion included in a body of a first conduit of a molding system, and connecting the first conduit to a second conduit.

A technical effect, amongst other technical effects, of the aspects of the present invention is reduction, at least in part, of leakage of a molding material from conduits of a molding system.

### BRIEF DESCRIPTION OF THE DRAWINGS

A better understanding of the exemplary embodiments of the present invention (including alternatives and/or variations thereof) may be obtained with reference to the detailed description of the exemplary embodiments of the present invention along with the following drawings, in which:

FIG. 1 is a cross-sectional view of a first conduit of an extruder of a molding system according to a first exemplary embodiment (which is the preferred embodiment);

FIGS. 2A and 2B are cross-sectional views of a first conduit of an extruder of a molding system according to a second exemplary embodiment;

FIG. 3 is a cross sectional view of a first conduit of an extruder of a molding system according to the third exemplary embodiment; and

FIG. 4 is a schematic representation of the first conduit of the extruder of the system of FIGS. 1, 2 and/or 3.

The drawings are not necessarily to scale and are sometimes illustrated by phantom lines, diagrammatic representations and fragmentary views. In certain instances, details that are not necessary for an understanding of the embodiments or that render other details difficult to perceive may have been omitted.

### DETAILED DESCRIPTION OF THE EXEMPLARY EMBODIMENTS

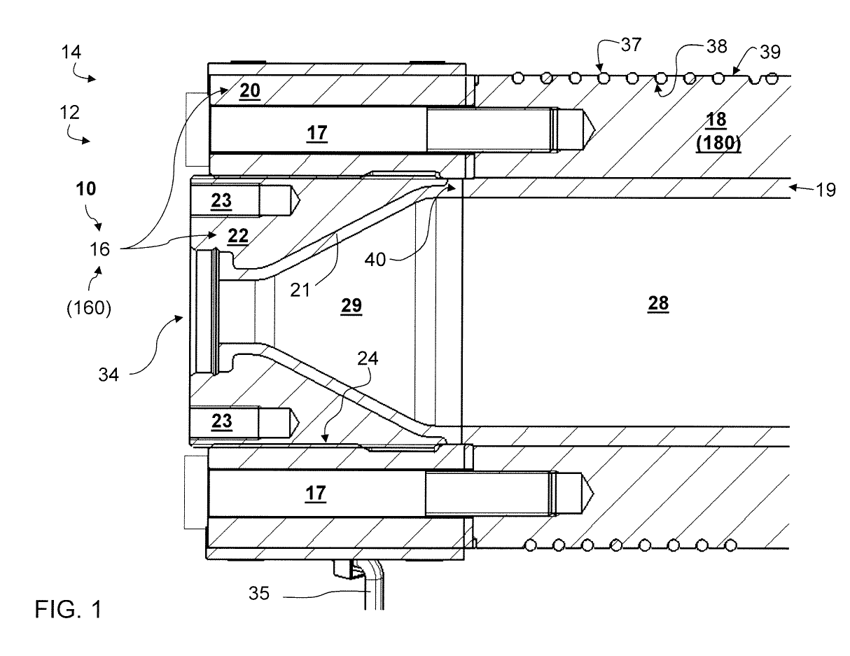

FIG. 1 is cross sectional view of a first conduit 10 (depicted in part) of an extruder 12 (also depicted in part) of a molding system 14 (also depicted in part, and hereafter referred to as the “system 14”) according to the first exemplary embodiment. The first conduit 10 includes a body 16 that is configured to be connectable with a second conduit 18. The body 16 has: (i) an outer portion 20, and also has (ii) an inner portion 22 that is receivable, at least in part, in the outer portion 20.

According to the first exemplary embodiment, the outer portion 20 is attachable to the second conduit 18 by way of bolts 17, and the inner portion 22 is rotatably mountable to the outer portion 20 by way of threads 24. The inner portion 22 is mounted to the outer portion 20 and then the outer portion 20 is connected to the second conduit 18. Alternatively, the outer portion 20 is mounted to the second conduit 18 and then the inner portion 22 is connected to the outer portion 20. Bolts 23 are used to mount a machine nozzle (not depicted) to the inner portion 22. Preferably, the inner portion 22 forms, at least in part, a sealing surface 40 that is sealable against the second conduit 18. The sealing surface 40 is located proximate of the outer circumferential surface of the second conduit 18. After the outer portion 20 and the inner portion 22 are assembled and the outer portion 20 is connected to the second conduit 18, a connection force acts (or is transmitted) through the bolt 17 to connect the outer portion 20 to the second conduit 18; also, the connection force acts or is transmitted through the threads 24 and along (directly) toward the sealing surface 40. The inner portion 22 is configured to: (i) receive a connection force from the outer portion 20, and (ii) transmit the connection force that was received from the outer portion 20 directly toward a sealing surface 40.

According to a variant, first conduit body 16 includes a barrel head 160. According to another variant, the second conduit 18 includes a barrel 180.

According to a variant, the system 14 is used to mold a metallic molding material, such as a magnesium alloy, a zinc alloy and/or an aluminum alloy. In this case, the second conduit 18 includes a liner 19 that is disposed along the inner circumferential surface of the second conduit 18; and as well, the inner portion 22 includes a liner 21 that is disposed or placed along the inner circumferential surface of the inner portion 22. The liners 21, 19 are, preferably, made of Stellite™ supplied by the Deloro Stellite Company (www.stellite.com) located in Goshen, Ind., USA. The second conduit 18 and the outer portion 20 and the inner portion 22 are made of Inconel™ supplied by the Special Metals Corporation located in Huntington, W. Va., USA (www.specialmetals.com). The sealing surface 40 is located along, at least in part, the liners 21, 19 (which are disposed proximate of the inner circumferential surface of the second conduit 18. However, according to another variant, the system 14 is used to mold polypropylene (or other plastic-based resin), and as such, the liners 21, 19 are not used, and the sealing surface 40 is located proximate of the inner circumferential surface of the second conduit 18.

The second conduit 18 defines a passageway 28 that extends through the second conduit 18 (at least in part); the inner portion 22 defines a channel 29 that extends through the inner portion 22. An egress 34 of the inner portion 22 permits a molding material to pass through over to a machine nozzle (not depicted).

Preferably, the barrel 180 defines a groove 38 on an outer surface 39 of the barrel 180. A heating wire 37 is placed in the groove 38. Alternatively, a heater band (not depicted) is used in place of the heating wire 37.

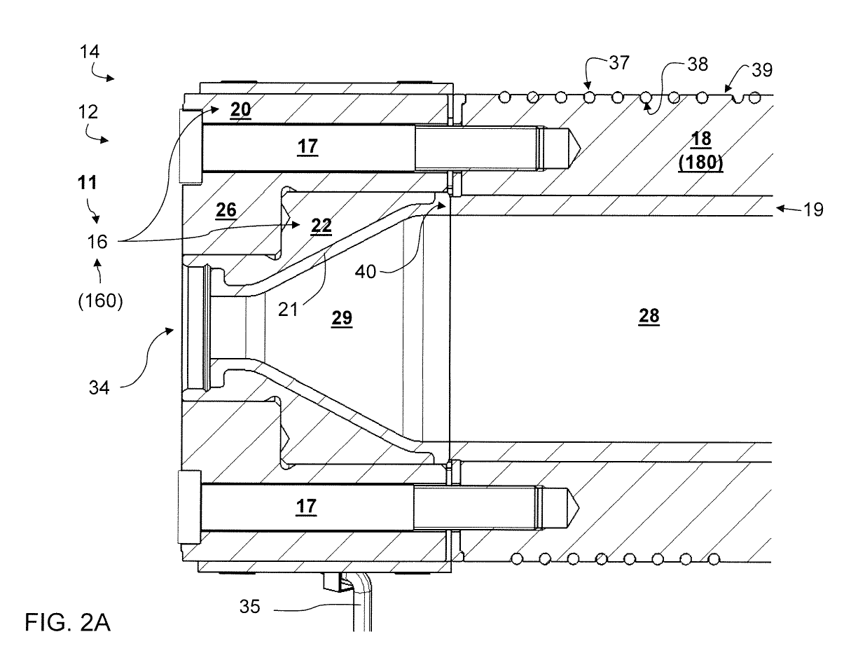

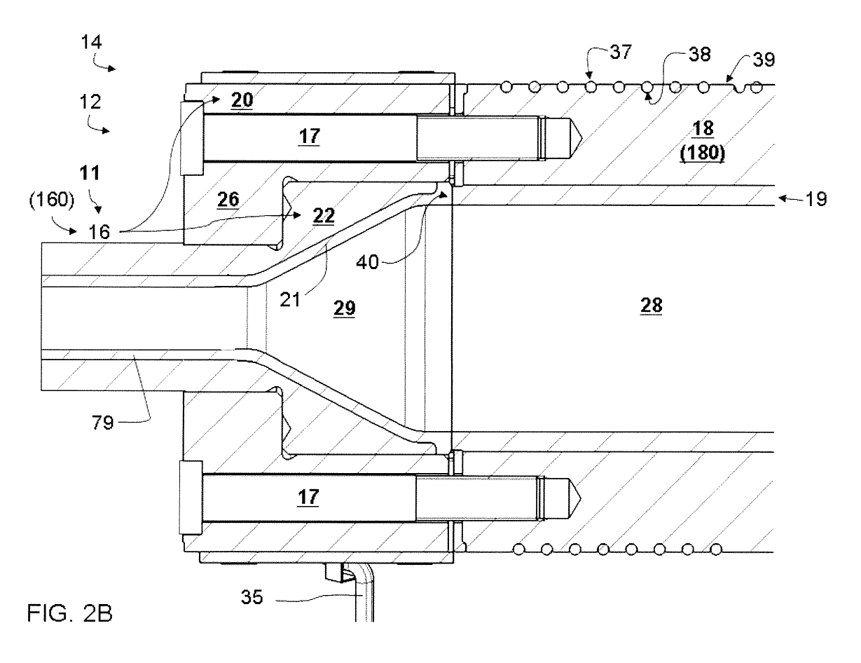

FIGS. 2A and 2B are cross-sectional views of the first conduit 11 of the extruder 12 of the system 14 according to the second exemplary embodiment. To facilitate an understanding of the second exemplary embodiment, elements of the second exemplary embodiment (that are similar to those of the first exemplary embodiment) are identified by similar reference numerals.

FIG. 2A depicts, according to the second exemplary embodiment, the outer portion 20 that includes a flange 26. The flange 22 extends radially inward. The flange 26 is abuttable against the inner portion 22. The threads 24 of FIG. 1 are not used in the second exemplary embodiment. Preferably, the outer portion 20 is donut (or torroidal) shaped and the inner portion 22 is disk shaped.

FIG. 2B depicts a variant of the first conduit 11 of the second exemplary embodiment, wherein the inner portion 22 is integral with a nozzle 79.

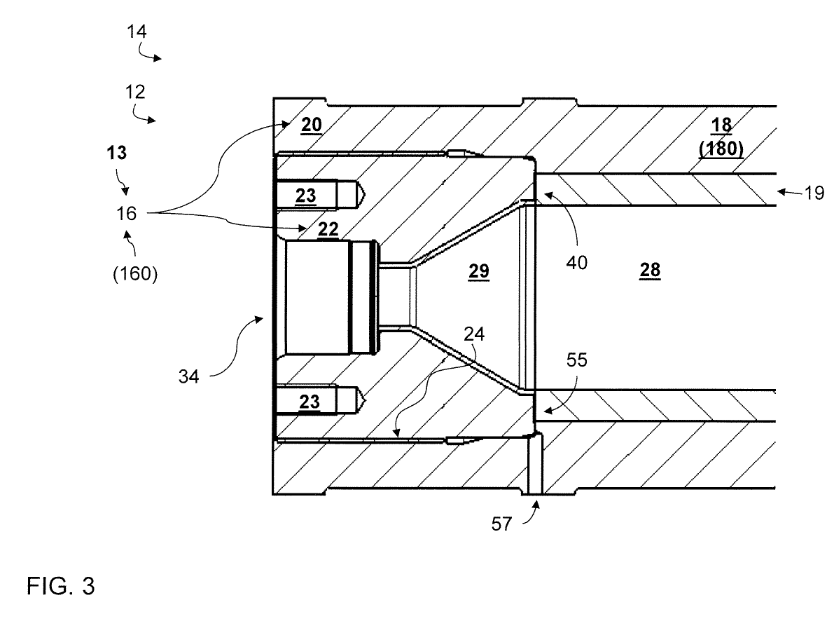

FIG. 3 is a cross-sectional view of a first conduit 13 of the extruder 12 of the system 14 according to the third exemplary embodiment. To facilitate an understanding of the third exemplary embodiment, elements of the third exemplary embodiment (that are similar to those of the first exemplary embodiment) are identified by similar reference numerals. According to the third exemplary embodiment, the outer portion 20 is integral with the second conduit 18. Threads 24 are used to threadably attach or engage the inner portion 22 with the outer portion 20. A weeping channel 57 in defined in the outer portion 20, and the weeping channel 57 is used to bleed or weep molten molding material if the seal 55 between the inner portion 22 and the outer portion 20 is breached (that is, breached for whatever reason).

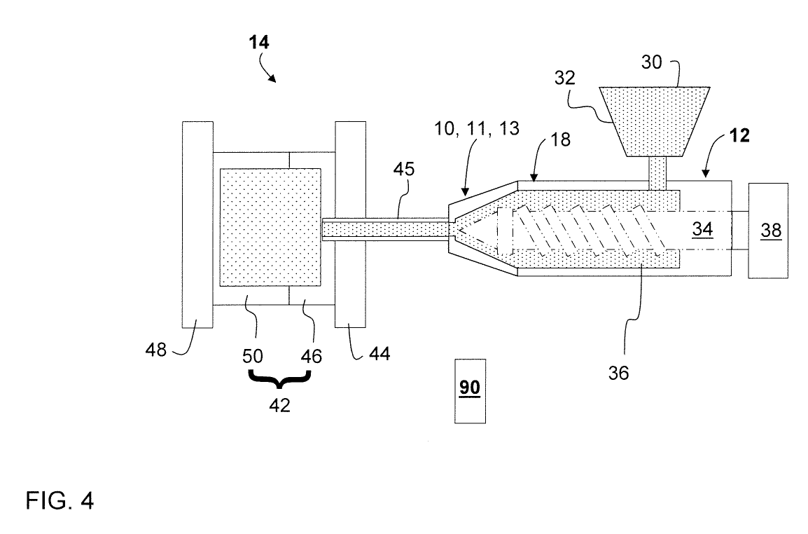

FIG. 4 is a schematic representation of the first conduit 10, 11, 13 of the extruder 12 of the system 14 of FIGS. 1, 2 and/or 3. The extruder 12 includes the second conduit 18, and also includes the first conduit 10 and/or 11 and/or 13. A hopper 30 is attached to the extruder 12, and the hopper 30 is used to convey a molding material 32 (that is not yet melted). A screw 34 is positioned in the extruder 12, and the screw 34 is used to process the molding material 32 into a molten molding material 36. A screw drive 38 is connected to the screw 34, and the screw drive 38 is used to drive the screw 34. A machine nozzle 45 is attached to the first conduits 10, 11, 13, and the machine nozzle 45 is used to convey the molten molding material 36 from the second conduit 18 to a mold 42. Alternatively, a hot runner 90 is connected to the machine nozzle 45, and the hot runner 90 is used to distribute the molten molding material 36 into sections of the mold 42 (or into separate cavities of the mold 42). The hot runner 90 is depicted detached from the mold 42.

The system 14 includes a stationary platen 44 that is configured to support a stationary mold portion 46 of the mold 42. The system 14 also includes a movable platen 48 that is configured to support a movable mold portion 50 of the mold 42. The system 14 also includes the extruder 12. The extruder 12 and the molding system 14 may be sold or supplied separately.

Preferably, the system 14 further includes, amongst other things, tangible subsystems, components, sub-assemblies, etc, that are known to persons skilled in the art (these items are not depicted and not described in detail since they are known). These other things may include: (i) a hot runner 90 (used if so required) that is mounted to the stationary platen 44 and the stationary mold portion 48 is then mounted to the hot runner 90 instead of being mounted to the stationary platen 44, (ii) tie bars (not depicted) that operatively couple the platens 44, 48 together, (iii) a clamping mechanism (not depicted) coupled to the tie bars and used to generate a clamping force that is transmitted to the platens 44, 48 via the tie bars (so that the mold 42 may be forced to remain together while a molding material is being injected in to the mold 42), (iv) a mold break force actuator (not depicted) coupled to the tie bars and used to generate a mold break force that is transmitted to the platens 44, 48 via the tie bars (so as to break apart the mold 42 once an article has been molded in the mold 42), (v) a platen stroking actuator (not depicted) coupled to the movable platen 48 and used to move the movable platen 48 away from the stationary platen 44 so that the molded article may be removed from the mold 42, (vi) hydraulic and/or electrical control equipment, and (vii) a controller (not depicted) that is operatively coupled to the system 14 so as to control and coordinate the processes associated with the system 14, etc.

The description of the exemplary embodiments provides examples of the present invention, and these examples do not limit the scope of the present invention. It is understood that the scope of the present invention is limited by the claims. The exemplary embodiments described above may be adapted for specific conditions and/or functions, and may be further extended to a variety of other applications that are within the scope of the present invention. Having thus described the exemplary embodiments, it will be apparent that modifications and enhancements are possible without departing from the concepts as described. It is to be understood that the exemplary embodiments illustrate the aspects of the invention. Reference herein to details of the illustrated embodiments is not intended to limit the scope of the claims. The claims themselves recite those features regarded as essential to the present invention. Preferable embodiments of the present invention are subject of the dependent claims. Therefore, what is to be protected by way of letters patent are limited only by the scope of the following claims:

What is claimed is:

1. A first conduit of an extruder of a molding system, comprising:
a body configured to be connectable with a second conduit, the body configured to have an outer portion, the body also configured to have an inner portion, the inner portion configured to be receivable, at least in part, in the outer portion.

2. The first conduit of claim 1, wherein the first conduit body includes a barrel head.

3. The first conduit of claim 1, wherein the second conduit includes a barrel.

4. The first conduit of claim 1, wherein the inner portion forms, at least in part, a sealing surface being sealable against the second conduit.

5. The first conduit of claim 1, wherein a connection force line is transmittable directly toward a sealing surface, the inner portion forms, at least in part, a sealing surface being sealable against the second conduit.

6. The first conduit of claim 1, wherein the outer portion is attachable to the second conduit.

7. The first conduit of claim 1, wherein the inner portion is configured to:
receive a connection force from the outer portion; and
transmit the connection force that was received from the outer portion directly toward a sealing surface, the inner portion forms, at least in part, a sealing surface being sealable against the second conduit.

8. The first conduit of claim 1, wherein the outer portion defines a weeping channel, and the weeping channel is used to bleed or weep molten molding material if a seal between the inner portion and the outer portion is breached.

9. The first conduit of claim 1, wherein the outer portion includes a flange extending radially inward, the flange being abuttable against the inner portion.

10. The first conduit of claim 1, wherein the outer portion is integral with the second conduit, and the inner portion having threads threadably engage the outer portion.

11. The first conduit of claim 1, wherein the inner portion is rotatably mountable to the outer portion.

12. The first conduit of claim 1, wherein the inner portion is integral with a nozzle.

13. A first conduit of an extruder of a molding system, comprising:
a body connected with a second conduit, the body having an outer portion, the body also having an inner portion, the inner portion received, at least in part, in the outer portion.

14. An extruder of a molding system, comprising:
a first conduit having a body, the body connected with a second conduit, the body having an outer portion, and the body also having an inner portion, and the inner portion received, at least in part, in the outer portion.

15. The extruder of claim 14, wherein the first conduit body includes a barrel head.

16. The extruder of claim 14, wherein the second conduit includes a barrel.

17. An extruder of a molding system, comprising:
a first conduit; and
a second conduit,
wherein the first conduit has a body, the body connected with a second conduit, the body has an outer portion, and the body also has an inner portion, and the inner portion is received, at least in part, in the outer portion.

18. An extruder of a molding system, comprising:
a first conduit configured to have a body, the body configured to be connectable with a second conduit, the body configured to have an outer portion, the body also configured to have an inner portion, and the inner portion configured to be receivable, at least in part, in the outer portion.

19. A molding system, comprising:
a stationary platen supporting a stationary mold portion of a mold;
a movable platen supporting a movable mold portion of the mold; and
an extruder including a first conduit, the first conduit having a body, the body connected with a second conduit, the body having an outer portion, and the body also having an inner portion, and the inner portion received, at least in part, in the outer portion.

20. The molding system of claim 18, wherein the first conduit body includes a barrel head.

21. The molding system of claim 18, wherein the second conduit includes a barrel.

22. A molding system, comprising:
a stationary platen supporting a stationary mold portion of a mold;
a movable platen supporting a movable mold portion of the mold; and
an extruder including:
a first conduit; and
a second conduit, wherein the first conduit has a body, the body connected with a second conduit, the body has an outer portion, and the body also has an inner portion, and the inner portion is received, at least in part, in the outer portion.

23. A molding system, comprising:
a stationary platen configured to support a stationary mold portion of a mold;
a movable platen configured to support a movable mold portion of the mold; and
an extruder configured to includes a first conduit, the first conduit configured to have a body, the body configured to be connectable with a second conduit, the body configured to have an outer portion, the body also configured to have an inner portion, and the inner portion configured to be receivable, at least in part, in the outer portion.

24. A molding system, comprising:
a mold having a stationary mold portion, the mold also having a movable mold portion of the mold;
a stationary platen supporting the stationary mold portion of the mold;
a movable platen supporting the movable mold portion of the mold; and
an extruder including a first conduit, the first conduit having a body, the body connected with a second conduit, the body having an outer portion, and the body also having an inner portion, and the inner portion received, at least in part, in the outer portion.

25. A hot runner of a molding system, comprising:
a first conduit having a body, the body connected with a second conduit, the body having an outer portion, and the body also having an inner portion, and the inner portion received, at least in part, in the outer portion.

26. The hot runner of claim 23, wherein the first conduit body includes a barrel head.

27. The hot runner of claim 23, wherein the second conduit includes a barrel.

28. A molding system, comprising:
a hot runner, including:
a first conduit; and
a second conduit, wherein the first conduit has a body, the body connected with a second conduit, the body has an outer portion, and the body also has an inner portion, and the inner portion is received, at least in part, in the outer portion.

29. A method, comprising:
receiving an inner portion, at least in part, in an outer portion, the inner portion and the outer portion included in a body of a first conduit of a molding system; and
connecting the first conduit to a second conduit.
